(19) United States
(12) Patent Application Publication
(10) Pub. No.: US 2026/0176146 A1
(43) Pub. Date: Jun. 25, 2026

(54) Non-Spherical Colloidal Silica, Preparation Method and Use thereof

(71) Applicant: Zhejiang Xinchuangna Electronic Technology CO.,LTD., Jiaxing (CN)

(72) Inventors: Siqi WEI, Jiaxing (CN); Zhengjian ZHU, Jiaxing (CN)

(73) Assignee: Zhejiang Xinchuangna Electronic Technology CO.,LTD., Jiaxing (CN)

(21) Appl. No.: 19/132,390

(22) PCT Filed: Mar. 17, 2023
(86) PCT No.: PCT/CN2023/082271

§ 371 Date: May 23, 2025

(30) Foreign Application Priority Data
Nov. 24, 2022 (CN) 202211496393.0

(51) Int. Cl. C01B 33/141; C09G 1/02; C09K 3/14

(52) U.S. Cl. CPC C01B 33/141; C09G 1/02; C09K 3/1409; C01P 2004/01; C01P 2004/54; C01P 2004/62; C01P 2004/64

(57) ABSTRACT

Provided is a non-spherical colloidal silica, a preparation method and use thereof. The non-spherical colloidal silica has a particle size of 35-150 nm and an aspect ratio of 1.5-2.5. The preparation method includes: 1) adding a first mixture including a first organic solvent, a base, and water to a second mixture including an alkoxysilane and a second organic solvent to react to obtain non-spherical silica nuclei; 2) using the non-spherical silica nuclei as a primary mother liquor, adding water, a base, and alkoxysilane in at least one step to perform at least one step of particle growth, obtaining an organic solution of non-spherical colloidal silica; 3) replacing the organic solvent in the organic solution of non-spherical colloidal silica with an equal volume of water. The non-spherical colloidal silica exhibits a higher polishing rate while maintaining surface quality during polishing and has extremely low total metal impurity content.

### FIELD OF TECHNOLOGY

The present disclosure belongs to the technical field of inorganic nanomaterials, and particularly relates to a non-spherical colloidal silica, a preparation method and use thereof.

### BACKGROUND

Chemical mechanical polishing (CMP) planarization technology is a key process in the preparation of integrated circuit chips. The polishing slurry is a critical material in the CMP process. As the technology nodes of integrated circuits continue to shrink, higher quality requirements are imposed on CMP polishing slurries, while costs are required to be increasingly lower. Polishing slurries mainly consist of abrasive particles and chemical additives. Abrasive particles are particles that adhere to the surface of the object being polished and perform a cutting function through physical action. High-end applications typically use colloidal silica as the abrasive. Colloidal silica is generally spherical with smooth edges and low hardness, causing minimal damage to the wafer surface during polishing. However, it suffers from the problem of low polishing rates. In recent years, studies have found that using non-spherical particles as abrasives can increase grinding resistance, thereby effectively improving polishing rates.

To obtain non-spherical silica particles, the “cation induction method” is often employed, which involves selecting suitable divalent or trivalent cations (e.g., Ca²⁺, Mg²⁺, Al³⁺) as morphology control agents to obtain colloidal silica with elongated structures. For example, patents CN103408027A, CN101402829A, and CN101626979A all use this method. However, when metal salts are added to control particle morphology, the introduction of metal impurities makes this approach unsuitable for integrated circuit polishing processes that require high purity.

Patent CN110655087A provides a method for preparing colloidal silica using an aqueous sodium silicate solution as the raw material, where the morphology of the particles is controlled by adjusting the feed rate of the stabilizer potassium hydroxide solution. However, since sodium silicate and potassium hydroxide are used as raw materials, the inevitable residue of alkali metals leads to reduced purity, making it difficult to apply in integrated circuit polishing.

The Stoeber method, which involves the hydrolysis of alkoxysilanes, easily yields non-spherical particles with high purity. For example, patents CN102390838A and Japanese Patent Application Laid-Open No. Hei 11-60232 describe the preparation of non-spherical colloidal silica particles by adjusting parameters such as the feed rate of alkoxysilane, ammonium ion content, water content, and reaction temperature. However, the primary solid content of the obtained silica is very low, less than 5%, with high alcohol consumption, low production efficiency, and high costs, making it unsuitable for large-scale production.

Patent CN112537774A describes a method for stably producing silica sols with smaller roundness using tetramethoxysilane. The roundness of the particles is adjusted by adding organic acids to the reaction solution. However, the addition of organic acids can cause anion contamination, which may adversely affect the polishing process.

Patent CN102164853B also describes the preparation of colloidal silica particles with numerous curved or branched structures using tetramethoxysilane. However, due to the poor stability of the tetramethoxysilane hydrolysis solution, the concentration of the hydrolysis solution is low, and its storage stability is poor, requiring immediate use or low-temperature storage. This results in high energy consumption and is unfavorable for industrial-scale production.

### SUMMARY

The present disclosure provides a non-spherical colloidal silica, a preparation method and use thereof.

The first aspect of the present disclosure provides a non-spherical colloidal silica, a particle size of the non-spherical colloidal silica ranges from 35 to 150 nm, such as 35 to 35.6 nm, 35.6 to 84.6 nm, 84.6 to 86.9 nm, 86.9 to 91.8 nm, 91.8 to 117.8 nm, 117.8 to 146.8 nm, or 146.8 to 150 nm, and an aspect ratio of the non-spherical colloidal silica ranges from 1.5 to 2.5, such as 1.5 to 1.8, 1.8 to 2.0, 2.0 to 2.1, 2.1 to 2.2, or 2.2 to 2.5.

In some embodiments, the non-spherical colloidal silica has a pH value of 6.5 to 8.0, e.g., 6.5 to 6.56, 6.56 to 7.00, 7.00 to 7.20, 7.20 to 7.29, 7.29 to 7.50, or 7.50 to 8.00;
and/or, the non-spherical colloidal silica has a solid content of 20 to 25 wt %, e.g., 20 to 21.25 wt %, 21.25 to 21.75 wt %, or 21.75 to 25 wt %;
and/or, the non-spherical colloidal silica has a total metal content of <0.5 ppm.

The second aspect of the present disclosure provides a preparation method for the non-spherical colloidal silica, including the following steps.
1) Adding a first mixture including a first organic solvent, a base, and water to a second mixture including an alkoxysilane and a second organic solvent to react to obtain non-spherical silica nuclei with a particle size of 20 to 30 nm.
2) Using the non-spherical silica nuclei as a primary mother liquor, adding water, a base, and alkoxysilane in at least one step to perform at least one step of particle growth, obtaining an organic solution of non-spherical colloidal silica with a particle size of 35 to 85 nm.
Ultra-pure water (resistivity: 18.2 MΩ·cm) is preferred for the water.
3) Replacing the organic solvent in the organic solution of non-spherical colloidal silica with an equal volume of water.

In some embodiments, the method further includes step 4): concentrating the material obtained from step 3), e.g., by evaporating excess water.

In some embodiments, the concentration temperature is 100° C.;

and/or, the concentrated solution has a solid content of 20 to 25 wt %.

In some embodiments, between steps 2) and 3), the method further includes taking 0.25 to 1 times the organic solution of non-spherical colloidal silica obtained from step 2) as a secondary mother liquor, adding water, a base, and alkoxysilane in at least one step to continue at least one step of particle growth, obtaining an organic solution including non-spherical colloidal silica particles, and the particles have a size range of more than 85 nm and less than or equal to 150 nm.

In some embodiments, the method further includes at least one of the following:
i1) The base added in each step is aqueous ammonia.
i2) The alkoxysilane added in each step is selected from at least one of tetraethyl orthosilicate (TEOS) and tetramethyl orthosilicate (TMOS).
i3) The mass ratio of water, base, and alkoxysilane added in each step is in a range of 1:(0.95 to 1.25):(5 to 10).
i4) The reaction temperature for particle growth in each step ranges from 20 to 40° C.
i5) The reaction time for particle growth in each step ranges from 2 to 4 hours.
i6) The mass ratio of the total alkoxysilane added between steps 2) and 3) to 0.25 to 1 times the total alkoxysilane added in steps 1) and 2) is 1:0.25 to 1:10.60 (e.g., 1:0.25 to 1:0.53, 1:0.53 to 1:2.6, or 1:2.6 to 1:10.60. Specifically, for example, when 0.25 times the organic solution of non-spherical colloidal silica obtained from Step 2) is taken as the secondary mother liquor, the mass ratio of the total alkoxysilane added between Step 2) and Step 3) to 0.25 times the total alkoxysilane added in Step 1) and Step 2) is 1:0.25 to 1:10.60.

In some embodiments, the method further includes at least one of the following:
1a) The first organic solvent in step 1) is an alcohol solvent.
1b) The base in step 1) is aqueous ammonia.
1c) The alkoxysilane in step 1) is selected from at least one of tetraethyl orthosilicate (TEOS) and tetramethyl orthosilicate (TMOS).
1d) The second organic solvent in step 1) is an alcohol solvent.
1e) In step 1), the concentration of the first organic solvent in the reaction system ranges from 5 to 8 wt %.
1f) In step 1), the concentration of the base in the reaction system ranges from 1.8 to 2.2 wt %.
1g) In step 1), the concentration of water in the reaction system ranges from 2.1 to 3.3 wt %.
1h) In step 1), the concentration of the alkoxysilane in the reaction system ranges from 4 to 13 wt %.
1i) In step 1), the concentration of the second organic solvent in the reaction system ranges from 73.5 to 87.1 wt %, such as 73.5 to 77.6 wt %, 77.6 to 82.8 wt %, or 82.8 to 87.1 wt %.
1j) In step 1), the reaction temperature ranges from 20 to 40° C.
1k) In step 1), the reaction time ranges from 5 to 15 h, such as 5 to 7 h, 7 to 10 h, or 10 to 15 h.
2a) In step 2), the base added in each step is aqueous ammonia.
2b) In step 2), the alkoxysilane added in each step is selected from at least one of tetraethyl orthosilicate (TEOS) and tetramethyl orthosilicate (TMOS).
2c) In step 2), the mass ratio of water, base, and alkoxysilane added in each step is in a range of 1:(0.95 to 1.25):(5 to 10).
2d) In step 2), the reaction time for particle growth in each step ranges from 2 to 4 h.
2e) In step 2), the reaction temperature for particle growth in each step ranges from 20 to 40° C.
2f) In step 2), the mass ratio of the total alkoxysilane added in step 2) to that added in step 1) ranges from 3:1 to 18:1, such as 3:1 to 17:1 or 17:1 to 18:1.
3a) In step 3), the organic solvent in the organic solution of non-spherical colloidal silica is evaporated and replaced with an equal volume of water. The organic solvent is removed by evaporation while maintaining a constant liquid level, and the alcohol in the system is displaced with an equal volume of water, such as ultra-pure water. When the temperature reaches 100° C., it indicates complete removal of the organic solvent, yielding an aqueous solution of colloidal silica.

In some embodiments, the method further includes at least one of the following:
1a1) In 1a), the first organic solvent is ethanol.
1d1) In 1d), the second organic solvent is ethanol.
2f1) In 2f), the mass ratio of the total alkoxysilane added in step 2) to that added in step 1) is 1:1.05 to 1:10.6.
3a1) In 3a), the evaporated organic solvent is condensed and recycled.

The third aspect of the present disclosure provides the use of the non-spherical colloidal silica as a polishing slurry in preparing integrated circuits.

As described above, the present disclosure offers at least one of the following advantages:
1) The preparation method of the present application is simple and convenient. Under normal pressure and low temperature conditions, through hydrolysis and condensation of alkoxysilanes while controlling parameters such as feeding sequence, material ratio, and reaction temperature, non-spherical silica nuclei with particle sizes of 20-30 nm can be obtained. Using these nuclei as mother liquor for particle growth, a multi-stage growth mode can be adopted to obtain medium-sized nanoparticles of 35-85 nm, completing a first-stage growth. Then, using the 35-85 nm particles as secondary mother liquor for continued growth, large-sized particles of 86-150 nm can be obtained, completing a second-stage growth.
2) The preparation method is easy to operate, stable, and eliminates the need for the addition of organic or inorganic additives that could introduce metal or anion impurities. It achieves high primary solid content (>10%) and low cost, making it suitable for industrial-scale manufacturing.
3) The obtained non-spherical colloidal silica has a particle size of 35 to 150 nm, an aspect ratio of 1.5 to 2.5, a solid content of 20 to 25 wt %, and a total metal content of <0.5 ppm. Compared with traditional spherical particles, the non-spherical particles exhibit higher polishing rates without compromising surface quality, while maintaining extremely low levels of metal impurities, making them particularly suitable for applications in integrated circuit polishing processes.

### BRIEF DESCRIPTION OF THE DRAWINGS

FIG. 1 shows the electron micrograph of non-spherical colloidal silica particles prepared in Example 4 of the present disclosure.

### DETAILED DESCRIPTION

The following specific embodiments illustrate the implementation of the present disclosure, and those skilled in the art can readily understand other advantages and effects of the present disclosure from the content disclosed in this specification.

It should be understood that the scope of protection of the present disclosure is not limited to the specific embodiments described below. It should also be understood that the terminology used in the embodiments of the present disclosure is intended to describe specific embodiments and not to limit the scope of protection of the present disclosure. Unless otherwise specified, experimental methods in the following embodiments are generally carried out under conventional conditions or according to the conditions recommended by the manufacturers.

When numerical ranges are provided in the examples, it should be understood that, unless otherwise specified, any numerical value between the two endpoints of the range, as well as the endpoints themselves, may be selected. Unless otherwise defined, all technical and scientific terms used in the present disclosure have the same meanings as commonly understood by those skilled in the art. In addition to the specific methods, equipment, and materials used in the examples, any methods, equipment, and materials similar or equivalent to those described in the examples of the present disclosure may also be used to implement the invention, based on the present disclosure and the prior art known to those skilled in the art.

### Example 1

(1) 240 g of tetraethyl orthosilicate (TEOS) was added to 1,433 g of ethanol and stirred uniformly to prepare mixture A. The temperature of mixture A was maintained at 40° C. Mixture B, consisting of 92 g of ethanol, 40 g of aqueous ammonia, and 40 g of ultrapure water, was added dropwise to mixture A over 60 minutes. After the addition of mixture B, stirring was continued for 7 hours to obtain colloidal silica nuclei with a particle size of 20.5 nm.

(2) Using the obtained colloidal silica nuclei as the mother liquor, aqueous ammonia, ultrapure water, and tetraethyl orthosilicate were added in six steps for nucleus growth. Each addition consisted of 15 g of aqueous ammonia, 12 g of ultrapure water, and 120 g of tetraethyl orthosilicate, with a constant-temperature reaction at 40° C. for 4 hours before the next addition. After the growth reaction, an alcohol solution of colloidal silica with a primary solid content of 10 wt % was obtained.

(3) The colloidal silica alcohol solution obtained in step (2) was heated and stirred to evaporate the alcohol from the system. During evaporation, the liquid level was kept constant, and the ethanol in the system was replaced with an equal volume of ultrapure water. When the temperature reached 100° C., the alcohol removal process was completed, yielding an aqueous colloidal silica solution. The evaporated ethanol was collected and recycled during the process.

(4) The aqueous colloidal silica solution obtained in step (3) was further concentrated to 20 wt % or higher using a heating and concentration method.

(5) The average particle size of the non-spherical particles, as measured by laser particle size analysis (dynamic light scattering), was 35.6 nm, with a pH of 6.56 and a final product solid content of 20.18 wt %. The aspect ratio of the non-spherical colloidal silica particles was 2.5. The aspect ratio refers to the average value of the ratio of the major axis to the minor axis of particles measured in scanning electron micrographs, typically based on 200 randomly tested particles. The total metal content was <0.5 ppm. The total metal content refers to the sum of 13 metal elements (Na, Mg, Al, K, Ca, Cr, Mn, Fe, Ni, Cu, Zn, Ag, and Pb) in the non-spherical colloidal silica particles, measured by inductively coupled plasma mass spectrometry (ICP-MS).

### Example 2

(1) 70 g of tetraethyl orthosilicate was added to 1,391 g of ethanol and stirred uniformly to prepare mixture A. The temperature of mixture A was maintained at 20° C. Mixture B, consisting of 134 g of ethanol, 30 g of aqueous ammonia, and 55 g of ultrapure water, was added dropwise to mixture A over 295 minutes. After the addition of mixture B, stirring was continued for 10 hours to obtain colloidal silica nuclei with a particle size of 29.5 nm.

(2) Using the obtained colloidal silica nuclei as the mother liquor, aqueous ammonia, ultrapure water, and tetraethyl orthosilicate were added in ten steps for nucleus growth. Each addition consisted of 22.8 g of aqueous ammonia, 24 g of ultrapure water, and 120 g of tetraethyl orthosilicate, with a constant-temperature reaction at 20° C. for 2 hours before the next addition. After the growth reaction, an alcohol solution of colloidal silica with a primary solid content of 10.77 wt % was obtained.

(3) The colloidal silica alcohol solution obtained in step (2) was heated and stirred to evaporate the alcohol from the system. During evaporation, the liquid level was kept constant, and the ethanol in the system was replaced with an equal volume of ultrapure water. When the temperature reached 100° C., the alcohol removal process was completed, yielding an aqueous colloidal silica solution. The evaporated ethanol was collected and recycled during the process.

(4) The aqueous colloidal silica solution obtained in step (3) was further concentrated to 20 wt % or higher using a heating and concentration method.

(5) The average particle size of the non-spherical particles, as measured by laser particle size analysis (dynamic light scattering), was 84.6 nm, with a pH of 7.20 and a final product solid content of 24.98 wt %. The aspect ratio of the non-spherical colloidal silica particles was 2.2 (tested using the same method as in Example 1). The total metal content of the non-spherical colloidal silica particles was <0.5 ppm (tested using the same method as in Example 1).

### Example 3

Following step (2) in Example 2, an alcohol solution of colloidal silica with a primary solid content of 10.77 wt % was prepared. This alcohol solution was used as a secondary mother liquor for further growth into larger particles. In this alcohol solution, aqueous ammonia, ultrapure water, and tetraethyl orthosilicate were added in one step for particle growth. Specifically, 22.8 g of aqueous ammonia, 24 g of ultrapure water, and 120 g of tetraethyl orthosilicate were added sequentially, followed by a constant-temperature reaction at 20° C. for 4 h. The reaction was then terminated, yielding an alcohol solution of colloidal silica with a primary solid content of 11.23 wt %.

The colloidal silica alcohol solution was heated and stirred to evaporate the alcohol from the system. During evaporation, the liquid level was maintained constant, and the ethanol in the system was replaced with an equal volume of ultrapure water. When the temperature reached 100° C., the alcohol removal process was completed. The evaporated ethanol was collected and recycled during the process.

The aqueous colloidal silica solution was further concentrated to 20 wt % or higher using a heating and concentration method.

The average particle size of the non-spherical colloidal silica particles, as measured by laser particle size analysis (dynamic light scattering), was 86.9 nm, with a pH of 7.29 and a final product solid content of 21.75 wt %. The aspect ratio of the non-spherical colloidal silica particles was 2.1 (tested using the same method as in Example 1). The total metal content of the non-spherical colloidal silica particles was <0.5 ppm (tested using the same method as in Example 1).

### Example 4

Following step (2) in Example 2, an alcohol solution of colloidal silica with a primary solid content of 10.77 wt % was prepared. A quarter (837 g) of this alcohol solution was taken as a secondary mother liquor for further growth into larger particles. In this alcohol solution, aqueous ammonia, ultrapure water, and tetraethyl orthosilicate were added in one step for particle growth. Specifically, 15 g of aqueous ammonia, 12 g of ultrapure water, and 120 g of tetraethyl orthosilicate were added sequentially, followed by a constant-temperature reaction at 20° C. for 4 h. The reaction was then terminated, yielding an alcohol solution of colloidal silica with a primary solid content of 12.62 wt %.

The colloidal silica alcohol solution was heated and stirred to evaporate the alcohol from the system. During evaporation, the liquid level was maintained constant, and the ethanol in the system was replaced with an equal volume of ultrapure water. When the temperature reached 100° C., the alcohol removal process was completed. The evaporated ethanol was collected and recycled during the process.

The aqueous colloidal silica solution was further concentrated to 20 wt % or higher using a heating and concentration method.

The average particle size of the non-spherical particles, as measured by laser particle size analysis (dynamic light scattering), was 91.8 nm, with a pH of 7.50 and a final product solid content of 21.25 wt %. The aspect ratio of the non-spherical colloidal silica particles was 2.0 (tested using the same method as in Example 1). The total metal content of the non-spherical colloidal silica particles was <0.5 ppm (tested using the same method as in Example 1).

### Example 5

Following step (2) in Example 2, an alcohol solution of colloidal silica with a primary solid content of 10.77 wt % was prepared. A quarter (837 g) of this alcohol solution was taken as a secondary mother liquor for further growth into larger particles. In this alcohol solution, aqueous ammonia, ultrapure water, and tetraethyl orthosilicate were added in five steps for particle growth. Each addition consisted of 15 g of aqueous ammonia, 12 g of ultrapure water, and 120 g of tetraethyl orthosilicate, with a constant-temperature reaction at 20° C. for 2 h before the next addition. After the growth reaction, an alcohol solution of colloidal silica with a primary solid content of 16.57 wt % was obtained.

The colloidal silica alcohol solution was heated and stirred to evaporate the alcohol from the system. During evaporation, the liquid level was maintained constant, and the ethanol in the system was replaced with an equal volume of ultrapure water. When the temperature reached 100° C., the alcohol removal process was completed. The evaporated ethanol was collected and recycled during the process.

The aqueous colloidal silica solution was further concentrated to 20 wt % or higher using a heating and concentration method.

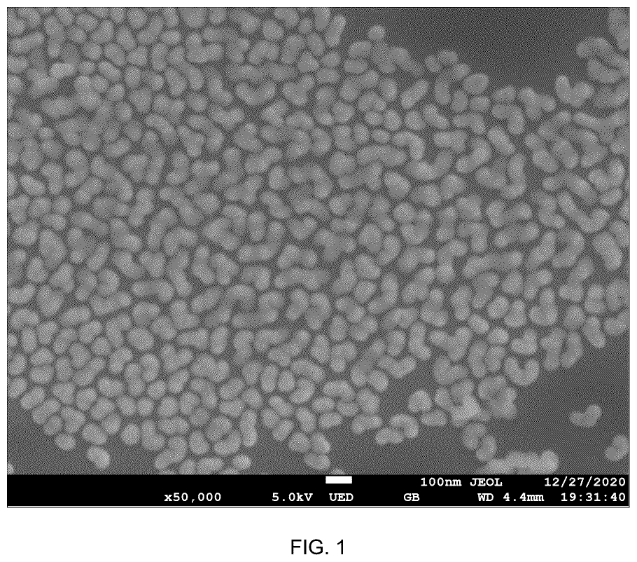

The average particle size of the non-spherical particles, as measured by laser particle size analysis (dynamic light scattering), was 117.8 nm, with a pH of 8.00 and a final product solid content of 21.25 wt %. The aspect ratio of the non-spherical colloidal silica particles was 1.8 (tested using the same method as in Example 1). The total metal content of the non-spherical colloidal silica particles was <0.5 ppm (tested using the same method as in Example 1). A scanning electron micrograph of the silica particles is shown in FIG. 1.

### Example 6

Following step (2) in Example 2, an alcohol solution of colloidal silica with a primary solid content of 10.77 wt % was prepared. A quarter (837 g) of this alcohol solution was taken as a secondary mother liquor for further growth into larger particles. In this alcohol solution, aqueous ammonia, ultrapure water, and tetraethyl orthosilicate were added in ten steps for particle growth. Each addition consisted of 15 g of aqueous ammonia, 12 g of ultrapure water, and 120 g of tetraethyl orthosilicate, with a constant-temperature reaction at 20° C. for 2 h before the next addition. After the growth reaction, an alcohol solution of colloidal silica with a primary solid content of 18.68 wt % was obtained.

The colloidal silica alcohol solution was heated and stirred to evaporate the alcohol from the system. During evaporation, the liquid level was maintained constant, and the ethanol in the system was replaced with an equal volume of ultrapure water. When the temperature reached 100° C., the alcohol removal process was completed. The evaporated ethanol was collected and recycled during the process.

The aqueous colloidal silica solution was further concentrated to 20 wt % or higher using a heating and concentration method.

The average particle size of the non-spherical particles, as measured by laser particle size analysis (dynamic light scattering), was 146.8 nm, with a pH of 7.00 and a final product solid content of 21.25 wt %. The aspect ratio of the non-spherical colloidal silica particles was 1.5 (tested using the same method as in Example 1). The total metal content of the non-spherical colloidal silica particles was <0.5 ppm (tested using the same method as in Example 1).

### Comparative Example 1

(1) 240 g of tetraethyl orthosilicate was added to 700 g of ethanol and stirred uniformly to prepare mixture A. Mixture A was quickly added to mixture B, which was maintained at a constant temperature of 40° C. and consisted of 825 g of ethanol, 40 g of aqueous ammonia, and 40 g of ultrapure water. After the addition of mixture A, stirring was continued for 7 h to obtain spherical colloidal silica nuclei with a particle size of 30.5 nm.

(2) Using the obtained colloidal silica nuclei as the mother liquor, aqueous ammonia, ultrapure water, and tetraethyl orthosilicate were added in two steps for nucleus growth. Each addition consisted of 15 g of aqueous ammonia, 12 g of ultrapure water, and 120 g of tetraethyl orthosilicate, with a constant-temperature reaction at 40° C. for 4 h before the next addition. After the growth reaction, an alcohol solution of colloidal silica with a primary solid content of 6.37 wt % was obtained.

(3) The colloidal silica alcohol solution obtained in step (2) was heated and stirred to evaporate the alcohol from the system. During evaporation, the liquid level was maintained constant, and the ethanol in the system was replaced with an equal volume of ultrapure water. When the temperature reached 100° C., the alcohol removal process was completed, yielding an aqueous colloidal silica solution. The evaporated ethanol was collected and recycled during the process.

(4) The aqueous colloidal silica solution obtained in step (3) was further concentrated to 20 wt % or higher using a heating and concentration method.

(5) The average particle size of the spherical particles measured by laser particle size analyzer (dynamic light scattering) was 37.4 nm, with a pH value of 6.85 and a final product solid content of 21.30 wt %. The aspect ratio of the spherical colloidal silica particles was 1.1. The aspect ratio refers to the average value of the ratio of the major axis to the minor axis of particles measurable in scanning electron micrographs, typically determined by randomly testing 200 particles.

### Comparative Example 2

The polishing performance of the non-spherical colloidal silica from Examples 1-6 was compared with that of the spherical colloidal silica from Comparative Example 1, as shown in Table 1.

The polishing rate and surface roughness data of polished wafers in Table 1 were obtained by using polishing slurries prepared from the non-spherical colloidal silica of Examples 1-6 and the spherical colloidal silica of Comparative Example 1 for polishing silicon oxide dielectric layers.

The preparation method for polishing slurry was as follows. The non-spherical colloidal silica from Examples 1-6 and the spherical colloidal silica from Comparative Example 1 were diluted with ultrapure water to a concentration of 5% as needed, then adjusted to pH 4.5 with 5 wt % sulfuric acid solution. After thorough mixing, 1 kg was weighed out as the polishing slurry.

The polishing experiment was performed as follows. The silicon oxide dielectric layers used in the experiment were prepared by chemical vapor deposition (CVD) of tetraethyl orthosilicate (TEOS) on silicon wafers, with dimensions of 4 cm×4 cm. The 4 cm×4 cm silicon oxide dielectric layers were adhered to the polishing head by back film adsorption for polishing. The polishing parameters were set as follows: polishing pressure of 3.5 psi; polishing pad rotation speed of 90 rpm; wafer rotation speed of 90 rpm; polishing slurry flow rate of 125 ml/min; polishing time of 1.5 min. After each polishing, the polishing pad was conditioned for 5 minutes with a 4-inch diamond dressing disk. The polished silicon oxide wafers were ultrasonically cleaned in cleaning solution for 10 minutes and dried with nitrogen. The surface roughness (Ra) of polished silicon oxide wafers was observed by atomic force microscopy. The polishing rate was calculated by measuring the thickness difference before and after polishing at 13 points using a film thickness meter, with results listed in Table 1.

TABLE 1

| | Silica | | | Surface |
|---|---|---|---|---|
| | Concentration | | Polishing Rate | Roughness |
| Serial number | (wt %) | pH Value | (nm/min) | (nm) |
| Example 1 | 5 | 4.5 | 105 | 0.129 |
| Example 2 | 5 | 4.5 | 85 | 0.125 |
| Example 3 | 5 | 4.5 | 80 | 0.127 |
| Example 4 | 5 | 4.5 | 90 | 0.135 |
| Example 5 | 5 | 4.5 | 95 | 0.133 |
| Example 6 | 5 | 4.5 | 90 | 0.133 |
| Comparative | 5 | 4.5 | 71 | 0.131 |
| Example 1 | | | | |

Table 1 shows that, compared with Comparative Example 1, under the same silica concentration conditions, the polishing rate using the non-spherical colloidal silica from Examples 1-6 as polishing slurry was increased by more than 10% over Comparative Example 1. There was no significant difference in surface roughness of wafers after polishing with either non-spherical or spherical colloidal silica, indicating that the non-spherical colloidal silica improves polishing rate without affecting post-polishing surface quality.

The above examples intend to illustrate the embodiments of the present disclosure and should not be construed as limiting the invention. In addition, various modifications and variations of the methods and compositions described herein will be apparent to those skilled in the art. While the present disclosure has been particularly described with reference to various specific preferred embodiments, it should be understood that the present disclosure is not limited to these specific examples. Indeed, various modifications apparent to those skilled in the art for practicing the present disclosure are intended to be included within the scope of the invention.

1. A non-spherical colloidal silica, wherein the non-spherical colloidal silica has a particle size of 35 to 150 nm and an aspect ratio of 1.5 to 2.5.

2. The non-spherical colloidal silica of claim 1, wherein a pH value of the non-spherical colloidal silica ranges from 6.5 to 8.0;
and/or, a solid content of the non-spherical colloidal silica ranges from 20 to 25 wt %;
and/or, a total metal content of the non-spherical colloidal silica is <0.5 ppm.

3. A method for preparing the non-spherical colloidal silica of claim 1, comprising the following steps:
1) adding a first mixture comprising a first organic solvent, a base, and water to a second mixture comprising an alkoxysilane and a second organic solvent to react to obtain non-spherical silica nuclei with a particle size of 20 to 30 nm;
2) using the non-spherical silica nuclei as a primary mother liquor, adding water, a base, and an alkoxysilane in at least one step to perform at least one step of particle growth, obtaining an organic solution of non-spherical colloidal silica with a particle size of 35 to 85 nm;
3) replacing an organic solvent in the organic solution of non-spherical colloidal silica with an equal volume of water.

4. The method of claim 3, further comprising step 4): concentrating the material obtained in step 3).

5. The method of claim 4, wherein a concentration temperature is 100° C.; and/or a concentrated solution has a solid content of 20 to 25 wt %.

6. The method of claim 3, wherein between step 2) and step 3), the method further comprises: taking 0.25 to 1 times the organic solution of non-spherical colloidal silica obtained in step 2) as a secondary mother liquor, adding water, a base, and an alkoxysilane in at least one step to continue particle growth, obtaining an organic solution comprising non-spherical colloidal silica particles, wherein the particles having a size range of more than 85 nm and less than or equal to 150 nm.

7. The method of claim 6, further comprising at least one of the following:
i1) the base added in each step is aqueous ammonia;
i2) the alkoxysilane added in each step is selected from at least one of tetramethyl orthosilicate and tetraethyl orthosilicate;
i3) a mass ratio of water, the base, and the alkoxysilane added in each step is in a range of 1:(0.95 to 1.25):(5 to 10);
i4) a reaction temperature for particle growth in each step ranges from 20 to 40° C.;
i5) a reaction time for particle growth in each step ranges from 2 to 4 hours;
i6) a mass ratio of a total alkoxysilane added between step 2) and step 3) to 0.25 to 1 times a total alkoxysilane added in steps 1) and 2) is in a range of 1:0.25 to 1:10.60.

8. The method of claim 3, further comprising at least one of the following:
1a) in step 1), the first organic solvent is an alcohol solvent;
1b) in step 1), the base is aqueous ammonia;
1c) in step 1), the alkoxysilane is selected from at least one of tetramethyl orthosilicate and tetraethyl orthosilicate;
1d) in step 1), the second organic solvent is an alcohol solvent;
1e) in step 1), a concentration of the first organic solvent in the reaction system ranges from 5 to 8 wt %;
1f) in step 1), a concentration of the base in the reaction system ranges from 1.8 to 2.2 wt %;
1g) in step 1), a concentration of water in the reaction system ranges from 2.1 to 3.3 wt %;
1h) in step 1), a concentration of the alkoxysilane in the reaction system ranges from 4 to 13 wt %;
1i) in step 1), a concentration of the second organic solvent in the reaction system ranges from 73.5 to 87.1 wt %;
1j) in step 1), a reaction temperature ranges from 20 to 40° C.;
1k) in step 1), a reaction time ranges from 5 to 15 hours;
2a) in step 2), the base added in each step is aqueous ammonia;
2b) in step 2), the alkoxysilane added in each step is selected from at least one of tetramethyl orthosilicate and tetraethyl orthosilicate;
2c) in step 2), a mass ratio of water, base, and alkoxysilane added in each step is in a range of 1:(0.95 to 1.25):(5 to 10);
2d) in step 2), a reaction time for particle growth in each step ranges from 2 to 4 hours;
2e) in step 2), a reaction temperature for particle growth in each step ranges from 20 to 40° C.;
2f) in step 2), a mass ratio of the total alkoxysilane added in step 2) to the alkoxysilane added in step 1) ranges from 3:1 to 18:1;
3a) in step 3), the organic solvent in the organic solution of non-spherical colloidal silica is evaporated and replaced with an equal volume of water.

9. The method of claim 8, further comprising at least one of the following:
1a1) in 1a), the first organic solvent is ethanol;
1d1) in 1d), the second organic solvent is ethanol;
2f1) in 2f), the mass ratio of the total alkoxysilane added in step 2) to the alkoxysilane added in step 1) ranges from 8:1 to 13:1;
3a1) in 3a), the evaporated organic solvent is condensed and recycled.

10. Use of the non-spherical colloidal silica of claim 1 as a polishing slurry in preparing integrated circuits.
